(19) United States
(12) Patent Application Publication
(10) Pub. No.: US 2014/0176893 A1
(43) Pub. Date: Jun. 26, 2014

(54) DISPLAY DEVICE AND METHOD OF MANUFACTURING THE SAME

(71) Applicant: SAMSUNG DISPLAY CO., LTD., Yongin-city (KR)

(72) Inventors: Koichi SUGITANI, Hwaseong-si (KR); Seong Gyu Kwon, Suwon-si (KR); Joo-Han Bae, Seongnam-si (KR); Hoon Kang, Suwon-si (KR); Jae-Sung Kim, Suwon-si (KR); Jin-Young Choi, Incheon (KR); Jin Ho Ju, Seoul (KR); Dong Hyun Yu, Gwacheon-si (KR); Hyung-Il Jeon, Incheon-si (KR)

(73) Assignee: Samsung Display Co., Ltd., Yongin-city (KR)

(21) Appl. No.: 13/870,503

(22) Filed: Apr. 25, 2013

(30) Foreign Application Priority Data
Dec. 21, 2012 (KR) 10-2012-0151133

(51) Int. Cl. G02F 1/1343

(52) U.S. Cl. CPC G02F 1/134336
USPC 349/143; 445/25

(57) ABSTRACT

A display device according to an exemplary embodiment of the present invention includes a substrate including a plurality of pixel regions, a thin film transistor disposed on the substrate, and a pixel electrode connected to the thin film transistor and disposed in a first pixel region. A roof layer is disposed on the pixel electrode and spaced apart from the pixel electrode with a microcavity interposed therebetween. The plurality of pixel regions is disposed in a matrix form including a plurality of pixel rows and a plurality of pixel columns, the roof layer is disposed along the plurality of pixel rows, and the roof layer includes a bridge portion connecting the roof layers disposed in different pixel rows.

### CROSS-REFERENCE TO RELATED APPLICATION

This application claims priority from and the benefit of Korean Patent Application No. 10-2012-0151133, filed on Dec. 21, 2012, which is hereby incorporated by reference for all purposes as if fully set forth herein.

### BACKGROUND

1. Field

Exemplary embodiments of the present invention relate to a display device and a method of manufacturing the same, and more particularly, to a display device in which a cell gap is uniform and liquid crystal and an alignment layer are uniformly injected, and a method of manufacturing the same.

2. Discussion of the Background

An liquid crystal display (LCD) is currently one of the most widely used flat panel displays. An LCD includes two display panels on which field generating electrodes such as a pixel electrode and a common electrode are formed and a liquid crystal layer interposed therebetween. The LCD displays an image by applying a voltage to a field generating electrode to generate an electric field on the liquid crystal layer, determine alignment of liquid crystal molecules of the liquid crystal layer therethrough, and control polarization of incident light.

The two display panels constituting the LCD may be formed of a thin film transistor (TFT) array panel and a counter display panel. In the TFT array panel, a gate line transferring a gate signal and a data line transferring a data signal are formed to cross each other, and a TFT connected to the gate line and the data line, a pixel electrode connected to the TFT, and the like may be formed therein. A light blocking member, a color filter, a common electrode, and the like may be formed in the counter display panel. If necessary, the light blocking member, the color filter, and the common electrode may be formed in the TFT array panel.

However, in a LCD of the related art, there are problems in that two substrates are used and constituent elements are formed on the two substrates, and thus the display device may be heavy and thick, a cost thereof may be high, and a manufacturing time may be long.

The above information disclosed in this Background section is only for enhancement of understanding of the background of the invention and therefore it may contain information that does not form the prior art that is already known in this country to a person of ordinary skill in the art.

### SUMMARY

Exemplary embodiments of the present invention provide a display device and a method of manufacturing the same, which can reduce weight, thickness, cost, and manufacturing time by using one substrate.

Exemplary embodiments of the present invention also provide a display device in which a cell gap is uniform and an alignment layer is uniformly formed, and a method of manufacturing the same.

Additional features of the invention will be set forth in the description which follows, and in part will be apparent from the description, or may be learned by practice of the invention.

An exemplary embodiment of the present invention discloses a display device including a substrate including a plurality of pixel regions, a thin film transistor disposed on the substrate, and a pixel electrode connected to the thin film transistor and disposed in a first pixel region. A roof layer is disposed on the pixel electrode and spaced apart from the pixel electrode with a microcavity interposed therebetween. The plurality of pixel regions is disposed in a matrix form including a plurality of pixel rows and a plurality of pixel columns, the roof layer is disposed along the plurality of pixel rows, and the roof layer includes a bridge portion connecting the roof layers disposed in different pixel rows.

An exemplary embodiment of the present invention also discloses a display device including a substrate including a plurality of pixel regions, a thin film transistor disposed on the substrate, and a pixel electrode connected to the thin film transistor t and disposed in a first pixel region. A roof layer is disposed on the pixel electrode and spaced apart from the pixel electrode with a microcavity interposed therebetween. Microcavities are disposed in the pixel regions and are connected to each other.

An exemplary embodiment of the present invention also discloses a display device including a substrate including a plurality of pixel regions, a thin film transistor disposed on the substrate, and a pixel electrode connected to the thin film transistor and disposed in a first pixel region. A roof layer is disposed on the pixel electrode and spaced apart from the pixel electrode with a microcavity interposed therebetween, in which the roof layer includes a protruding portion protruding from a first side and a second side of the first pixel region.

An exemplary embodiment of the present invention also discloses a display device including a substrate including a plurality of pixel regions, a thin film transistor disposed on the substrate, and a pixel electrode connected to the thin film transistor and disposed in a first pixel region. A roof layer is disposed on the pixel electrode and spaced apart from the pixel electrode with a microcavity interposed therebetween, in which the microcavity is disposed in at least a portion of the first pixel region and an edge region surrounding the first pixel region.

An exemplary embodiment of the present invention also discloses a method of manufacturing a display device, the method including forming a thin film transistor on a substrate, forming a pixel electrode connected to the thin film transistor, the pixel electrode being disposed in a pixel region, forming a sacrificial layer on the pixel electrode, forming a roof layer on the sacrificial layer, forming a liquid crystal injection hole in the roof layer to expose a portion of the sacrificial layer, removing the sacrificial layer to form a microcavity between the pixel electrode and the roof layer, curing the roof layer, injecting liquid crystal through the liquid crystal injection hole; and forming an overcoat layer on the roof layer to seal the microcavity for each pixel region, in which a thickness of the sacrificial layer formed at a portion that is in contact with the liquid crystal injection hole is greater than a thickness of a residual portion.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a top plan view illustrating a display device according to an exemplary embodiment of the present invention.

FIG. 2 is a top plan view illustrating one pixel of the display device according to the exemplary embodiment of the present invention.

FIG. 3 is a cross-sectional view illustrating a portion of the display device according to the exemplary embodiment of the present invention, which is taken along line III-III of FIG. 1.

FIG. 4 is a cross-sectional view illustrating a portion of the display device according to the exemplary embodiment of the present invention, which is taken along line IV-IV of FIG. 1.

FIG. 5 is a cross-sectional view illustrating a portion of the display device according to the exemplary embodiment of the present invention, which is taken along line V-V of FIG. 1.

FIG. 6 is a top plan view illustrating the display device according to an exemplary embodiment of the present invention.

FIG. 7 is a cross-sectional view illustrating a portion of the display device according to the exemplary embodiment of the present invention, which is taken along line VII-VII of FIG. 6.

FIG. 8 is a top plan view illustrating the display device according to an exemplary embodiment of the present invention.

FIG. 9 is a cross-sectional view illustrating a portion of the display device according to the exemplary embodiment of the present invention, which is taken along line IX-IX of FIG. 8.

FIGS. 10 and 11 are top plan views illustrating the display device according to exemplary embodiments of the present invention.

FIG. 12 is a top plan view illustrating the display device according to an exemplary embodiment of the present invention.

FIGS. 13 and 14 are top plan views illustrating the display device according to exemplary embodiments of the present invention.

FIG. 15 is a cross-sectional view illustrating a portion of the display device according to an exemplary embodiment of the present invention.

FIG. 16 is a cross-sectional view illustrating a portion of the display device according to an exemplary embodiment of the present invention.

FIG. 17 is a cross-sectional view illustrating a portion of the display device according to an exemplary embodiment of the present invention.

FIGS. 18 to 21 are process cross-sectional views illustrating a method of manufacturing the display device according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

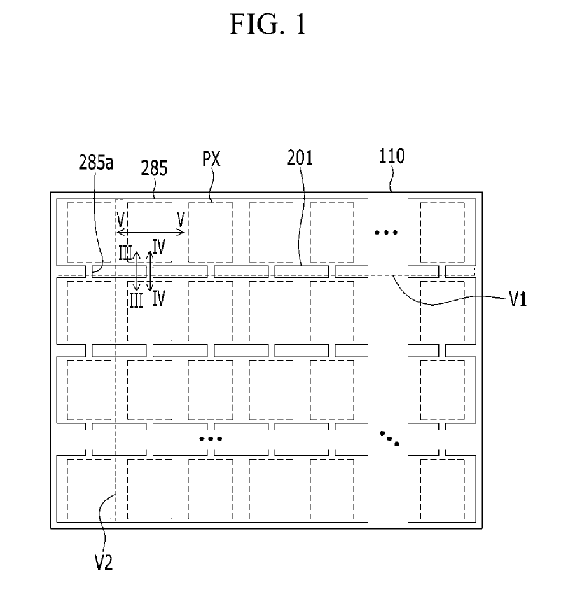

First, a display device according to an exemplary embodiment of the present invention will be described below with reference to FIGS. 1 to 5.

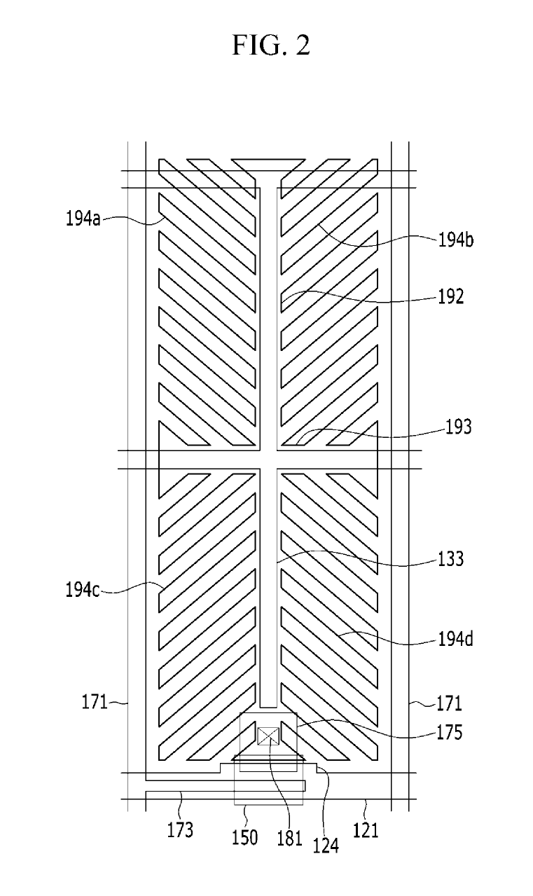

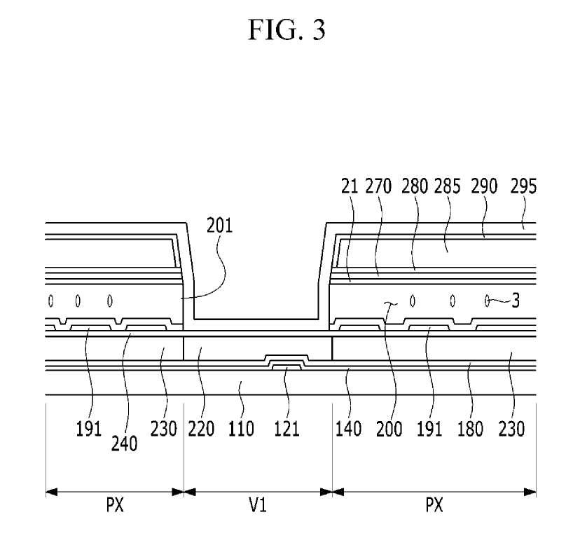

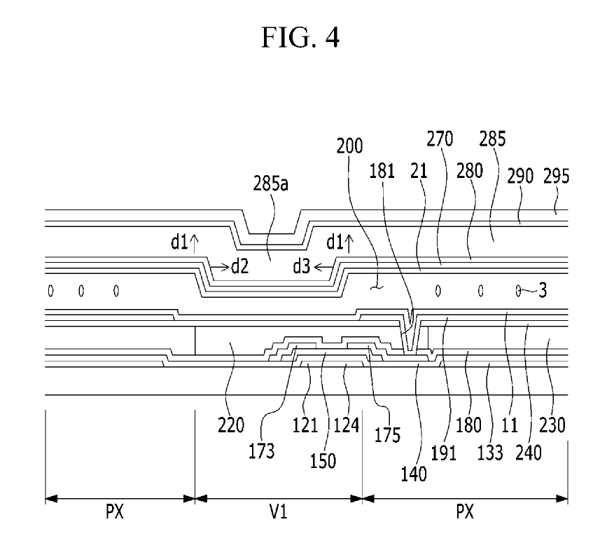

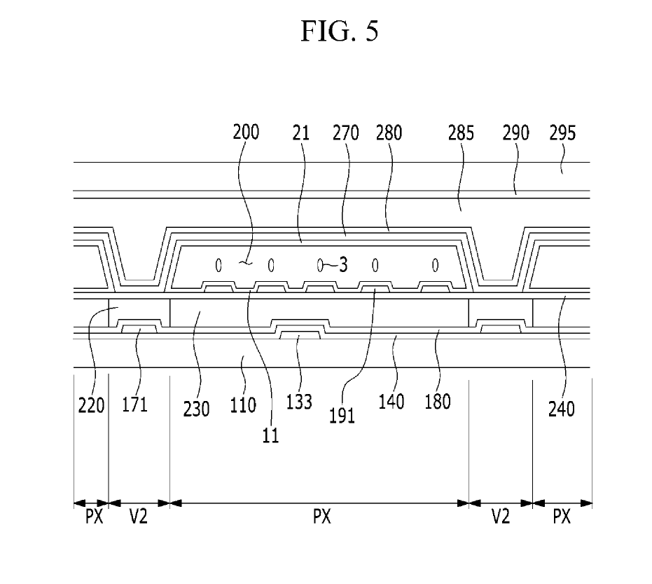

FIG. 1 is a top plan view illustrating a display device according to the present exemplary embodiment, and FIG. 2 is a top plan view illustrating one pixel of the display device according to the present exemplary embodiment. FIG. 3 is a cross-sectional view illustrating a portion of the display device according to the present exemplary embodiment, which is taken along line III-III of FIG. 1, FIG. 4 is a cross-sectional view illustrating a portion of the display device according to the present exemplary embodiment, which is taken along line IV-IV of FIG. 1, and FIG. 5 is a cross-sectional view illustrating a portion of the display device according to the present exemplary embodiment, which is taken along line V-V of FIG. 1.

The display device according to the present exemplary embodiment includes a substrate 110 made of a material such as glass or plastic.

The substrate 110 includes a plurality of pixel regions PX. A plurality of pixel regions PX is disposed in a matrix form including a plurality of pixel rows and a plurality of pixel columns. A first valley V1 is positioned between a plurality of pixel rows, and a second valley V2 is positioned between a plurality of pixel columns.

However, the disposal form of a plurality of pixel regions PX is not limited thereto, and many modifications thereof are feasible.

A gate line 121 is formed in one direction and a data line 171 is formed in another direction on the substrate 110. The gate line 121 may be formed in the first valley V1, and the data line 171 may be formed in the second valley V2. The gate line 121 and the data line 171 may be formed to cross each other. In this case, the pixel region PX of the substrate 110 may be defined by the gate line 121 and the data line 171 formed to cross each other.

The gate line 121 mainly extends in a horizontal direction, and a gate signal is transferred therethrough. Further, a gate electrode 124 protruding from the gate line 121 is formed. The gate signal is applied through the gate line 121 to the gate electrode 124.

A storage electrode 133 may be further formed in the pixel region PX so as not to be connected to the gate line 121 and the gate electrode 124. As illustrated in the drawings, the storage electrode 133 may be formed in a direction that is parallel to the gate line 121 and the data line 171. The storage electrode may also be formed in a direction that is parallel to only the gate line 121. A plurality of storage electrodes 133 formed in the adjacent pixel regions PXs is formed to be connected to each other. A predetermined voltage such as a common voltage is applied to the storage electrode 133.

A gate insulating layer 140 is formed on the gate line 121, the gate electrode 124, and the storage electrode 133. The gate insulating layer 140 may be formed of an inorganic insulating material such as silicon nitride (SiNₓ) and silicon oxide (SiOₓ). Further, the gate insulating layer 140 may be formed of a single layer or a multilayer.

A semiconductor layer 150 is formed on the gate insulating layer 140. The semiconductor layer 150 may be positioned on the gate electrode 124. Further, although not shown in the drawings, the semiconductor layer 150 may be formed to extend to a lower portion of the data line 171. The semiconductor layer 150 may be formed of amorphous silicon, polycrystalline silicon, metal oxide, or the like.

A source electrode 173 protruding from the data line 171, and a drain electrode 175 spaced apart from the source electrode 173 are formed on the semiconductor layer 150.

The data line 171 mainly extends in a vertical direction, and the data signal is transferred therethrough. The data signal transferred to the data line 171 is applied to the source electrode 173.

The gate electrode 124, the semiconductor layer 150, the source electrode 173, and the drain electrode 175 constitute one thin film transistor. When the thin film transistor is in an on-state, the data signal applied to the source electrode 173 is transferred to the drain electrode 175.

A passivation layer 180 is formed on the data line 171, the source electrode 173, the drain electrode 175, and the semiconductor layer 150 exposed between the source and drain electrodes 173 and 175. The passivation layer 180 may be formed of an organic insulating material or an inorganic insulating material, and formed of a single layer or a multilayer.

A color filter 230 is formed in each pixel region PX on the passivation layer 180. Each color filter 230 may display any one of three primary colors of red, green and blue colors. The color filter 230 is not limited to the three primary colors of red, green and blue colors, and may display cyan, magenta, yellow, and white-based colors.

A light blocking member 220 is formed in a region between the adjacent color filters 230. The light blocking member 220 may be formed on a boundary portion of the pixel regions PX and the thin film transistor to prevent a light leakage. That is, the light blocking member 220 may be formed in a first valley V1 and a second valley V2.

A first insulating layer 240 may be further formed on the color filter 230 and the light blocking member 220. The first insulating layer 240 may be formed of an inorganic insulating material such as silicon nitride (SiNₓ) and silicon oxide (SiOₓ). The first insulating layer 240 serves to protect the color filter 230 and the light blocking member 220 formed of the organic material, and may be omitted if necessary.

A contact hole 181 is formed through the first insulating layer 240, the light blocking member 220, and the passivation layer 180 so as to expose a portion of the drain electrode 175. The contact hole 181 may be formed through the color filter 230 instead of the light blocking member 220.

The pixel electrode 191 connected to the drain electrode 175 through the contact hole 181 is formed on the first insulating layer 240. The pixel electrode 191 is formed in each pixel region PX and connected to the drain electrode 175 to receive the data signal from the drain electrode 175 when the thin film transistor is in an on-state. The pixel electrode 191 may be formed of a transparent metal material such as indium-tin oxide (ITO) and indium-zinc oxide (IZO).

The pixel electrode 191 includes a horizontal stem portion 193, a vertical stem portion 192 that is orthogonal to the horizontal stem portion 193, and a plurality of first to fourth minute branch portions 194a, 194b, 194c, and 194d.

The horizontal stem portion 193 may be formed in a direction that is parallel to the gate line 121, and the vertical stem portion 192 may be formed in a direction that is parallel to the data line 171. The horizontal stem portion 193 may be formed at approximately an intermediate position between the two adjacent gate lines 121, and the vertical stem portion 192 may be formed at approximately an intermediate position between the two adjacent data lines 171.

One pixel region PX is divided into a first sub-pixel region, a second sub-pixel region, a third sub-pixel region, and a fourth sub-pixel region by the horizontal stem portion 193 and the vertical stem portion 192. The first sub-pixel region is positioned on a left side of the horizontal stem portion 193 and an upper side of the vertical stem portion 192, and the second sub-pixel region is positioned on a right side of the horizontal stem portion 193 and an upper side of the vertical stem portion 192. The third sub-pixel region is positioned on the left side of the horizontal stem portion 193 and a lower side of the vertical stem portion 192, and the fourth sub-pixel region is positioned on the right side of the horizontal stem portion 193 and a lower side of the vertical stem portion 192.

The first minute branch portion 194a is formed in the first sub-pixel region, and the second minute branch portion 194b is formed in the second sub-pixel region. The third minute branch portion 194c is formed in the third sub-pixel region, and the fourth minute branch portion 194d is formed in the fourth sub-pixel region.

The first minute branch portion 194a extends obliquely in an upper left direction from the horizontal stem portion 193 or the vertical stem portion 192, and the second minute branch portion 194b extends obliquely in an upper right direction from the horizontal stem portion 193 or the vertical stem portion 192. Further, the third minute branch portion 194c extends obliquely in a lower left direction from the horizontal stem portion 193 or the vertical stem portion 192 and the fourth minute branch portion 194d extends obliquely in a lower right direction from the horizontal stem portion 193 or the vertical stem portion 192.

The first to the fourth minute branch portions 194a-194d may be formed to have an angle of about 45° or 135° to the gate line 121 or the horizontal stem portion 193. Further, the first to the fourth minute branch portions 194a-194d of the adjacent sub-pixel regions may be formed to be orthogonal to each other.

According to the above description, the shape of the pixel electrode 191 illustrated in FIG. 1 is described, but the present invention is not limited thereto, and may be variously changed. Further, although it is described that one pixel region PX is divided into four sub-pixel regions, the pixel region according to the present invention may be divided into more regions, less regions, or it may not be divided into a plurality of sub-pixel regions.

A common electrode 270 is formed on the pixel electrode 191 to be spaced apart from the pixel electrode 191 by a predetermined distance. A microcavity 200 is formed between the pixel electrode 191 and the common electrode 270. A width and an area of the microcavity 200 may be variously modified according to resolution of the display device.

A liquid crystal 3 is filled in the microcavity 200. The liquid crystal 3 is formed of a plurality of liquid crystal molecules, and may be erected in a direction that is vertical to the substrate 110 in a state where an electric field is not applied. That is, vertical alignment may be performed. Further, the alignment is not limited thereto, and horizontal alignment may be performed.

The liquid crystal 3 may be formed of any one of nematic, smectic, cholesteric, and chiral liquid crystal materials. Further, the liquid crystal 3 may be formed of a negative type liquid crystal material or a positive type liquid crystal material.

In the above, it is described that the pixel electrode 191 is formed under the microcavity 200 and the common electrode 270 is formed on the microcavity 200, but the present invention is not limited thereto. Both the pixel electrode 191 and the common electrode 270 may be formed under the microcavity 200. In this case, the pixel electrode 191 and the common electrode 270 may be formed on the same layer, or they may be formed on different layers with an insulating layer interposed therebetween. In this case, the liquid crystal 3 may be formed to lie in a direction that is parallel to the substrate 110 in the microcavity 200.

A first alignment layer 11 is formed on the pixel electrode 191. The first alignment layer 11 may be formed on the first insulating layer 240 not covered with the pixel electrode 191.

A second alignment layer 21 is formed under the common electrode 270 to face the first alignment layer 11.

The first alignment layer 11 and the second alignment layer 21 may be formed of the vertical alignment layer, and may be formed of a material such as polyamic acid, polysiloxane, and polyimide. The first and the second alignment layers 11 and 21 may be connected to each other at an edge of the pixel region PX.

The microcavity 200 is surrounded by the pixel electrode 191 and the common electrode 270.

The common electrode 270 may be formed in the second valley V2 to come into direct contact with an upper portion of the first insulating layer 240, thus allowing the common electrode 270 to cover the left surface and the right surface of the microcavity 200. That is, the common electrode 270 is connected along a plurality of pixel rows, and the height of the portion of the common electrode 270 positioned in the second valley V2 is lower than the height of the portion of the common electrode 270 positioned in the pixel region PX, in relation to the substrate 110. This is because the microcavity 200 is not formed under the portion of the common electrode 270 positioned in the second valley V2.

The common electrode 270 is not formed in at least some regions of the first valley V1. That is, the common electrode 270 is formed so as not to cover at least a portion of the upper surface and the lower surface of the pixel region PX, thus allowing a portion of the microcavity 200 to be exposed to the outside. The surface at which the microcavity 200 is exposed is called a liquid crystal injection hole 201. The liquid crystal injection hole 201 is formed along the first valley V1, and the liquid crystal 3 is injected through the liquid crystal injection hole 201 into the microcavity 200.

According to the above description, the common electrode 270 covers the left surface and the right surface of the microcavity 200 and does not cover at least a portion of the upper surface and the lower surface, but the present invention is not limited thereto, and the common electrode 270 may be formed to cover another lateral surface of the microcavity 200. For example, the common electrode 270 may be formed to cover the upper surface and the lower surface of the microcavity 200 and not to cover at least a portion of the left surface and the right surface. In this case, the liquid crystal injection hole 201 may be formed along the second valley V2.

A second insulating layer 280 may be further formed on the common electrode 270. The second insulating layer 280 may be formed of an inorganic insulating material such as silicon nitride (SiNₓ) and silicon oxide (SiOₓ), and may be omitted if necessary.

The roof layer 285 is formed on the second insulating layer 280. The roof layer 285 may be formed of an organic material. The microcavity 200 is formed under the roof layer 285, and the shape of the microcavity 200 may be maintained by the roof layer 285.

The roof layer 285 is formed along a plurality of pixel rows like the common electrode 270, and a height thereof is lower than that of another portion of the roof layer 285 in the second valley V2. Further, the liquid crystal injection hole 201 is formed along the first valley V1 in roof layer 285 to expose a portion of the microcavity 200 therethrough.

The roof layer 285 includes a bridge portion 285a connecting the roof layers 285 positioned in the different pixel rows. The bridge portion 285a is formed in the first valley V1. The bridge portion 285a for connecting the roof layers 285 positioned in the two different pixel rows may be formed in the number of pixel regions PX included in one pixel row. That is, the bridge portion 285a may be formed every pixel column.

The bridge portion 285a is formed at an intermediate position between two adjacent second valleys V2. However, the present invention is not limited thereto, and the formation position of the bridge portion 285a may be variously changed. For example, the bridge portion 285a may be formed at a position at which the first valley V1 and the second valley V2 cross each other.

The height of the bridge portion 285a is lower than the height of the roof layer 285 positioned in the pixel region PX.

In order to form the microcavity 200 under the roof layer 285, first, a sacrificial layer (not shown) is formed at a portion at which the microcavity 200 is to be formed, and a process of removing the sacrificial layer is performed after the roof layer 285 is formed. In this case, the microcavity 200 is not formed under the roof layer 285 at a portion at which the sacrificial layer is not formed. For example, the microcavity 200 is not formed under the roof layer 285 in the second valley V2.

The sacrificial layer may be formed to have different thicknesses through a slit exposure or halftone exposure process. The thickness of the sacrificial layer corresponding to a portion of the roof layer 285, at which the bridge portion 285a is formed, may be less than that in the pixel region PX. The roof layers 285 formed on the sacrificial layer having different thicknesses thereby may have different heights in relation to the substrate 110. Accordingly, the height of the bridge portion 285a may be lower than the height of the roof layer 285 positioned in the pixel region PX.

After the roof layer 285 is formed, a curing process is performed in order to maintain the shape of the microcavity 200, and heat at high temperatures (ex. 220 degrees) is applied during the curing process. In this case, as illustrated in FIG. 4, stress occurs in a first direction d1 at an edge of the pixel region PX due to a difference between thermal expansion coefficients of lower and upper layers of the roof layer 285.

In the present exemplary embodiment, an end of the roof layer 285 positioned at the edge of the pixel region PX is connected to an end of the roof layer 285 of another pixel row. Further, the height of the bridge portion 285a connecting the roof layers 285 positioned in the different pixel rows is lower than that of the roof layer 285 positioned in the pixel region PX. Accordingly, the stress occurring in the first direction d1 during the curing process may be dispersed in a second direction d2 and a third direction d3. Accordingly, the stress occurring in the first direction d1 may be relatively reduced to prevent the shape of the roof layer 285 from being deformed at the edge of the pixel region PX.

Further, the roof layer 285 serves to maintain the shape of the microcavity 200, and the thickness of the microcavity 200 forms a cell gap. In the present exemplary embodiment, the cell gap can be uniformly maintained in the entire pixel region PX by preventing the roof layer 285 from being deformed.

The common electrode 270 is formed under the bridge portion 285a of the roof layer 285. Accordingly, the common electrodes 270 positioned in the different pixel rows may be connected to each other.

A third insulating layer 290 may be further formed on the roof layer 285. The third insulating layer 290 may be formed of an inorganic insulating material such as silicon nitride (SiNₓ) and silicon oxide (SiOₓ). The third insulating layer 290 may be formed to cover both an upper surface and a lateral surface of the roof layer 285. The third insulating layer 290 serves to protect the roof layer 285 formed of the organic material, and may be omitted if necessary.

An overcoat 295 may be formed on the third insulating layer 290. The overcoat 295 is formed to cover the liquid crystal injection hole 201 through which the microcavity 200 is exposed to the outside. That is, the overcoat 295 may seal the liquid crystal injection hole 201 so that the liquid crystal 3 formed in the microcavity 200 is not discharged to the outside. Since the overcoat 295 is in contact with the liquid crystal 3, the overcoat may be formed of a material that does not react with the liquid crystal 3.

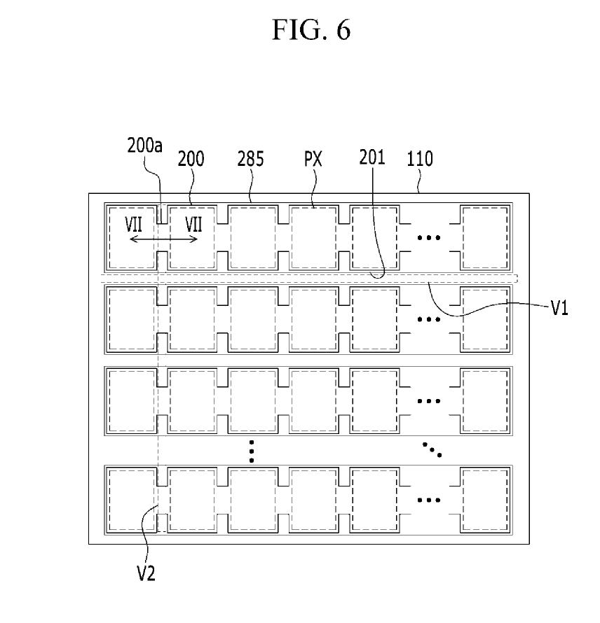

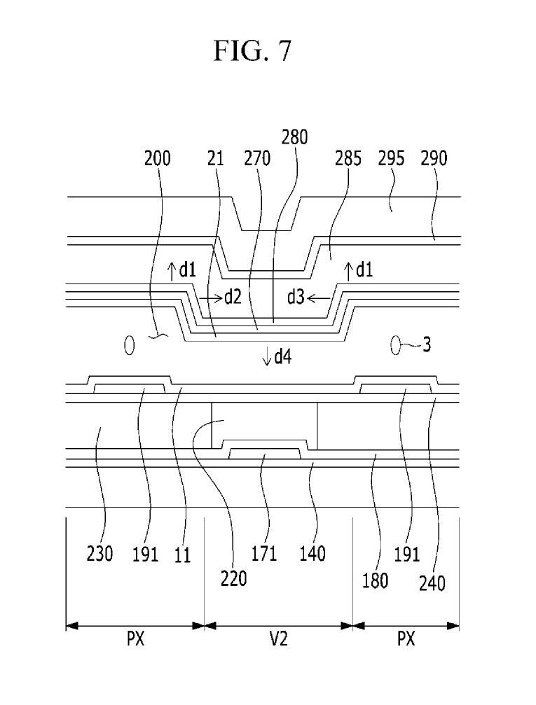

Next, the display device according to an exemplary embodiment of the present invention will be described below with reference to FIGS. 6 and 7.

Since the display device according to the exemplary embodiment illustrated in FIGS. 6 and 7 has many same elements as the display device according to the exemplary embodiment illustrated in FIGS. 1 to 5, a description thereof will be omitted and only a difference will be described below. One difference with the previous exemplary embodiment is that the microcavities formed in the different pixel regions PX are connected to each other, and will be described in more detail below.

FIG. 6 is a top plan view illustrating the display device according to the present exemplary embodiment, and FIG. 7 is a cross-sectional view illustrating a portion of the display device according to the present exemplary embodiment, which is taken along line VII-VII of FIG. 6.

In the display device according to the present exemplary embodiment, a thin film transistor and a pixel electrode 191 connected thereto are formed on a substrate 110. A roof layer 285 is formed on the pixel electrode 191 to be spaced apart from the pixel electrode 191 with a microcavity 200 interposed therebetween. A liquid crystal injection hole 201 is formed through the roof layer 285 to expose a portion of the microcavity 200, and a liquid crystal 3 is filled in the microcavity 200. An overcoat 295 is formed on the roof layer 285 to cover the liquid crystal injection hole 201, and seals the microcavity 200 for each pixel row.

In the previous exemplary embodiment, the microcavities 200 formed in the pixel regions PX positioned in the different columns are not connected to each other, but in the present exemplary embodiment, the microcavities 200 formed in the pixel regions PX positioned in the different columns are connected to each other.

A connection form of the microcavities 200 on a top plan view is illustrated in FIG. 6. The microcavities 200 formed in the same pixel row are connected to each other. That is, the microcavities 200 formed in the first pixel row are connected to each other, and the microcavities 200 formed in the second pixel row are connected to each other. The microcavity 200 formed in the first pixel row is separated from the microcavity 200 formed in the second pixel row.

The microcavities 200 positioned in the different pixel columns are connected in the second valley V2. Connection of the microcavities 200 may be performed in some regions of the second valley V2 between the two adjacent pixel regions PX. For example, connection of the microcavities 200 may be performed at an intermediate position between the two adjacent first valleys V1. However, the present invention is not limited thereto, and connection of the microcavities 200 may be performed in the entire region of the second valley V2 between the two adjacent pixel regions PX.

The roof layer 285 formed on the microcavity 200 is formed along a plurality of pixel rows, and the roof layers 285 positioned in the different pixel rows are separated from each other.

The roof layer 285 may be formed to be relatively thin in the second valley V2 in which connection of the microcavities 200 is performed. That is, the height of the roof layer 285 positioned at a boundary between a plurality of pixel regions PX is lower than the height of the roof layer 285 positioned in the pixel region PX. Accordingly, the thickness of a connection portion 200a of the microcavity 200 is less than the thickness of the microcavity 200 formed in the pixel region PX.

In order to form the microcavity 200 under the roof layer 285, first, a sacrificial layer (not shown) is formed at a portion at which the microcavity 200 is to be formed, and a process of removing the sacrificial layer is performed after the roof layer 285 is formed. In this case, the microcavity 200 is not formed under the roof layer 285 at a portion at which the sacrificial layer is not formed. For example, the microcavity 200 is not formed on upper and lower sides of the connection portion 200a of the microcavities 200. That is, the common electrode 270 may be formed on the upper and lower sides of the connection portion 200a of the microcavities 200 to come into direct contact with an upper portion of the first insulating layer 240.

The sacrificial layer may be formed to have different thicknesses through a slit exposure or halftone exposure process. The thickness of the sacrificial layer corresponding to the connection portion 200a of the microcavities 200 may be formed to be less than that in the pixel region PX. The roof layers 285 formed on the sacrificial layer having different heights thicknesses thereby have different heights. Accordingly, the height of the roof layer 285 positioned at a boundary between a plurality of pixel regions PX may be lower than the height of the roof layer 285 positioned in the pixel region PX.

After the roof layer 285 is formed, a curing process is performed in order to maintain the shape of the microcavity 200, and heat at high temperatures is applied during the curing process. In this case, as illustrated in FIG. 7, stress occurs in a first direction d1 at an edge of the pixel region PX due to a difference between thermal expansion coefficients of lower and upper layers of the roof layer 285.

In the present exemplary embodiment, the microcavities 200 in the different pixel regions PX in the second valley V2 are connected, and the thickness of the connection portion 200a of the microcavities 200 is less than that in the pixel region PX. The stress occurring in the first direction d1 during the curing process may be dispersed in a second direction d2, a third direction d3, and a fourth direction d4. Accordingly, the stress occurring in the first direction d1 may be relatively reduced to prevent the shape of the roof layer 285 from being changed at the edge of the pixel region PX.

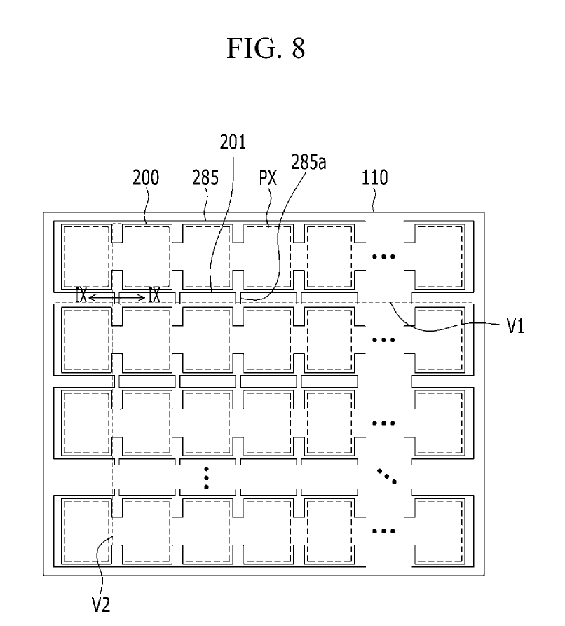

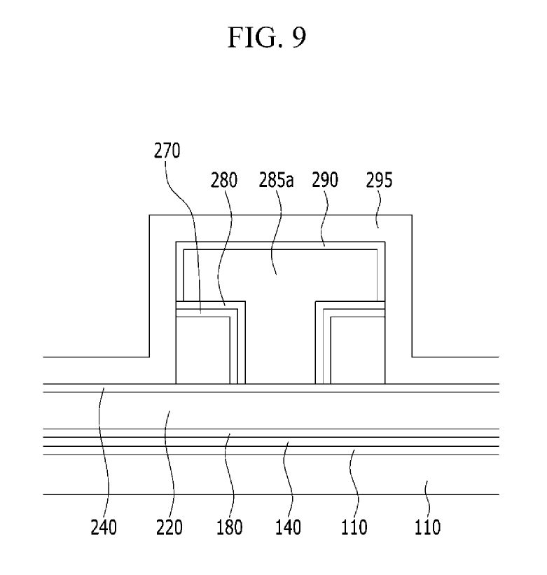

Next, the display device according to an exemplary embodiment of the present invention will be described below with reference to FIGS. 8 and 9.

Since the display device according to the exemplary embodiment of the present invention illustrated in FIGS. 8 and 9 has many same elements as the display device according to the exemplary embodiment illustrated in FIGS. 6 and 7, a description thereof will be omitted and only a difference will be described below. One difference with the previous exemplary embodiment is that the roof layers positioned in the different pixel rows are connected to each other, and will be described in more detail below.

FIG. 8 is a top plan view illustrating the display device according to the exemplary embodiment of the present invention, and FIG. 9 is a cross-sectional view illustrating a portion of the display device according to the exemplary embodiment of the present invention, which is taken along line IX-IX of FIG. 8.

The display device according to the present exemplary embodiment is the same as that of the previous exemplary embodiment in that the microcavities 200 formed in the same pixel row are connected to each other. The microcavities 200 in the two adjacent pixel regions positioned in the same pixel row are connected in the second valley V2.

In the previous exemplary embodiment, the roof layers 285 positioned in the different pixel rows are separated from each other, but in the present exemplary embodiment, the roof layers 285 positioned in the different pixel rows are connected to each other.

The roof layer 285 includes a bridge portion 285a connecting the roof layers 285 positioned in the different pixel rows. The bridge portion 285a is formed at a position at which the first valley V1 and the second valley V2 cross each other. However, the present invention is not limited thereto, and the formation position of the bridge portion 285a may be variously changed.

A cross-sectional view of the bridge portion 285a, which is taken in a row direction, may have a T shape. However, the present invention is not limited thereto, and a cross-sectional shape of the bridge portion 285a may be an I shape, a U shape, or the like.

The microcavities 200 are connected in the second valley V2, and thus a contact area of the roof layer 285 and the first insulating layer 240 is relatively reduced as compared to the case where the microcavities are not connected. Accordingly, the roof layer 285 may not come into contact with the first insulating layer 240 but may be sunk. In the present exemplary embodiment, the bridge portion 285a of the roof layer 285 may be formed at a position at which the first valley V1 and the second valley V2 cross each other and the bridge portion 285a may be formed to come into contact with the first insulating layer 240, thus compensating the reduced contact area. Accordingly, the roof layer 285 may stably contact the first insulating layer 240.

The microcavity 200 is exposed to the outside through a portion in which the roof layer 285 is not formed, and the exposed portion is called a liquid crystal injection hole 201. The liquid crystal injection hole 201 has a quadrangle shape in a top plan view.

However, the shape of the liquid crystal injection hole 201 may be variously changed.

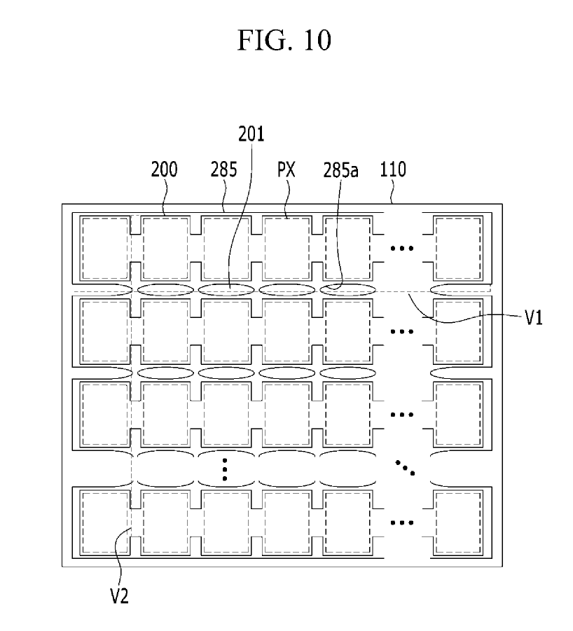

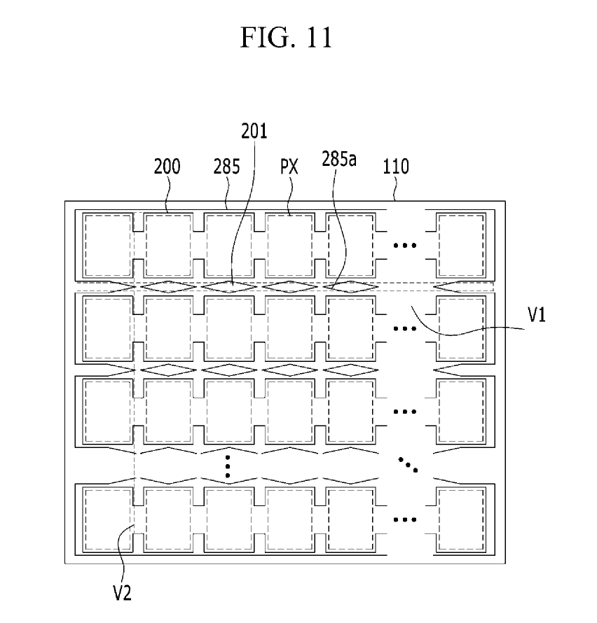

Hereinafter, the shape of the liquid crystal injection hole of the display device according to exemplary embodiments of the present invention will be described below with reference to FIGS. 10 and 11.

FIGS. 10 and 11 are top plan views illustrating the display device according to the exemplary embodiments of the present invention.

The liquid crystal injection hole 201 has an oval shape in FIG. 10, and the liquid crystal injection hole 201 has a rhombus shape in FIG. 11.

However, the present invention is not limited thereto, and the shape of the liquid crystal injection hole 201 in a top plan view may be variously changed. For example, the liquid crystal injection hole 201 may have a circle shape.

The edge of the liquid crystal injection hole 201 is almost identical with a boundary of the pixel region PX in FIG. 8, but a portion of the liquid crystal injection hole 201 is spaced apart from the boundary of the pixel region PX in FIGS. 10 and 11.

The deformation of the roof layer 285 mainly occurs at a portion that is adjacent to the liquid crystal injection hole 201 during a curing process. In the case where the deformation of the roof layer 285 occurs in the pixel region PX, the deformation affects a cell gap, which may allow a user to recognize the deformation. In the present exemplary embodiment, the portion at which the deformation of the roof layer 285 mainly occurs is formed in the first valley V1. Since a light blocking member is formed in the first valley V1, to prevent an image from being displayed, even though a deformation occurs in the cell gap, the deformation is not recognizable by a user. Accordingly, the cell gap may be uniformly maintained in the pixel region PX.

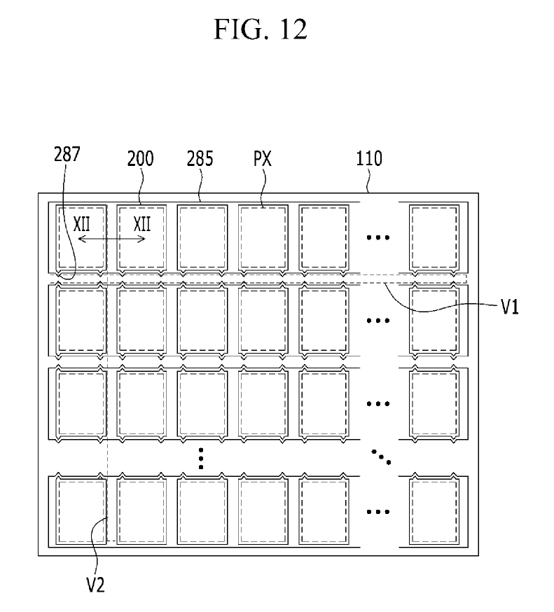

Next, the display device according to an exemplary embodiment of the present invention will be described below with reference to FIG. 12.

Since the display device according to the present exemplary embodiment illustrated in FIG. 12 has many same elements as the display device according to the exemplary embodiment of the present invention illustrated in FIGS. 1 to 5, a description thereof will be omitted and only a difference will be described below.

FIG. 12 is a top plan view illustrating the display device according to the exemplary embodiment of the present invention.

A plurality of pixel regions PX is formed on a substrate 110. A plurality of pixel regions PX is disposed in a matrix form including a plurality of pixel rows and a plurality of pixel columns.

A roof layer 285 is formed along the pixel row, and the roof layer 285 includes a protruding portion 287 protruding from the pixel region PX to a first valley V1.

The protruding portion 287 is formed to protrude from upper and lower sides of the pixel region PX, and is positioned in the first valley V1.

The shape of the protruding portion 287 is a triangle, and may be an isosceles triangle, an equilateral triangle, a right triangle, or the like.

The protruding portion 287 may be formed to be adjacent to the left and the right of a position at which the first valley V1 and a second valley V2 cross each other.

A liquid crystal (not shown) is filled in a microcavity 200 formed under the roof layer 285, and the liquid crystal is injected through a liquid crystal injection hole 201 by using a capillary phenomenon. In this case, a meniscus is formed around the liquid crystal injection hole 201.

Assuming that the liquid crystal injection hole 201 is formed to be almost identical with the edge of the pixel region PX, the meniscus has a shape that is concave toward the inside of the liquid crystal injection hole 201. Accordingly, a region having no liquid crystal 3 may exist at the edge of the pixel region PX, and a light leakage phenomenon may occur at the corresponding portion thereof.

In the present exemplary embodiment, a portion of the liquid crystal injection hole 201 may be positioned outside the pixel region PX by forming the roof layer 285 to have the protruding portion 287 at both edges of the upper and the lower sides of the pixel region PX. Accordingly, the meniscus may be formed outside the pixel region PX and the liquid crystal may be filled in the entire pixel region to prevent a light leakage phenomenon.

Although not illustrated in the drawings, a common electrode is formed under the protruding portion 287 of the roof layer 285.

Unlike the exemplary embodiment illustrated in FIG. 1, in FIG. 12, the bridge portion 285a of the roof layer 285 is not formed. However, the present invention is not limited thereto, and even in the exemplary embodiment illustrated in FIG. 12, the bridge portion 285a of the roof layer 285 may be further formed.

According to the above description, the shape and the position of the protruding portion 287 are described, but the present invention is not limited thereto, and various modifications thereof may be achieved.

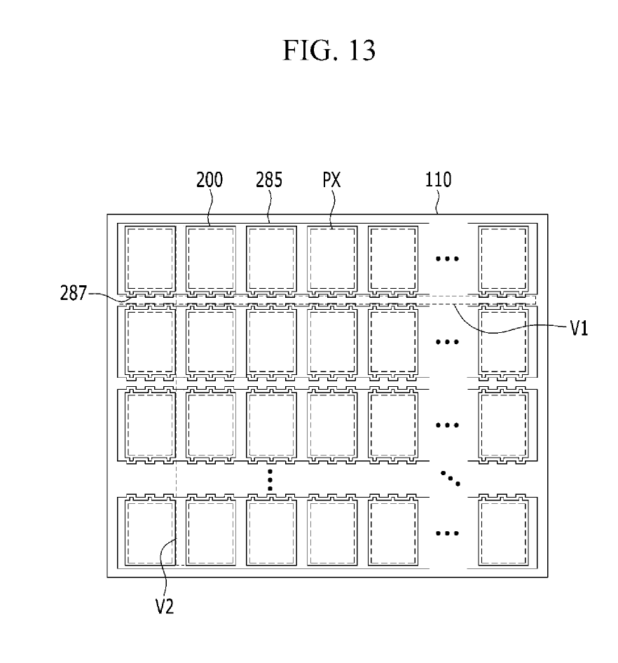

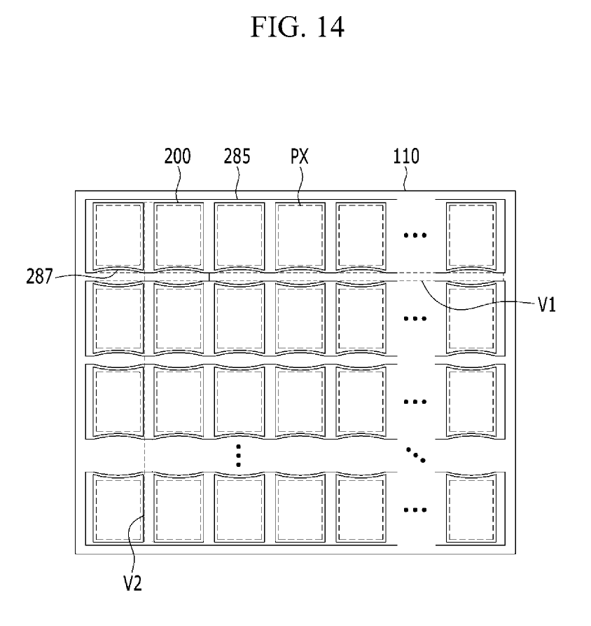

Hereinafter, the shape and the position of the protruding portion 287 of the roof layer 285 of the display device according to exemplary embodiments of the present invention will be described below with reference to FIGS. 13 and 14.

FIGS. 13 and 14 are top plan views illustrating the display device according to exemplary embodiments of the present invention.

The protruding portion 287 of the roof layer 285 has a quadrangle shape in FIG. 13. The protruding portion 287 of the roof layer 285 is formed to be adjacent to the left and the right of a position at which the first valley V1 and the second valley V2 cross each other, and also formed at the center between the two adjacent second valleys V2.

The protruding portion 287 of the roof layer 285 has a round shape in FIG. 14. The protruding portion 287 of the roof layer 285 is formed in the entire first valley V1, with the exception of a position at which the first valley V1 and the second valley V2 cross each other. The shape of the liquid crystal injection hole 201 on a top plan view may be determined by the shape of the protruding portion 287. In FIG. 14, the liquid crystal injection hole 201 may have a semi-oval shape.

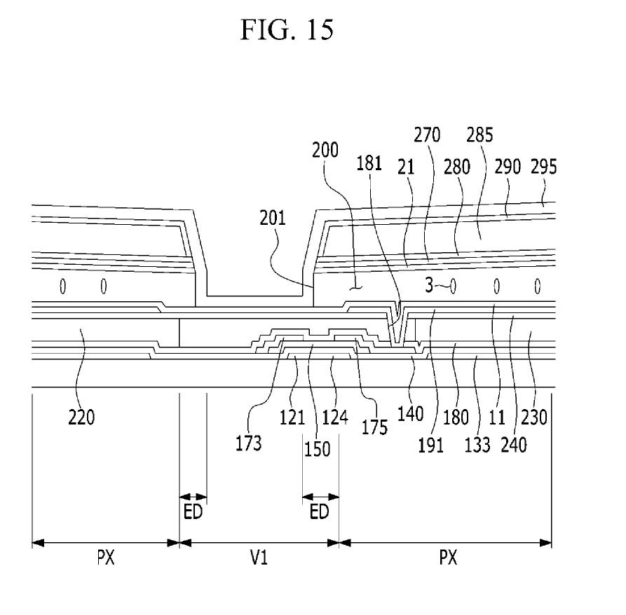

Hereinafter, the display device according to an exemplary embodiment of the present invention will be described below with reference to FIG. 15.

Since the display device according to the exemplary embodiment of the present invention illustrated in FIG. 15 has many same elements as the display device according to the exemplary embodiment illustrated in FIGS. 1 to 5, a description thereof will be omitted and only a difference will be described below. One difference with the previous exemplary embodiment is that the microcavity is formed in at least a portion of the edge region surrounding the pixel region and the microcavity positioned in the edge region is formed to be small, and will be described in more detail below.

FIG. 15 is a cross-sectional view illustrating a portion of the display device according to an exemplary embodiment of the present invention. FIG. 15 illustrates a portion of the two adjacent pixels belonging to the same pixel column.

In the display device according to the present exemplary embodiment, a thin film transistor and a pixel electrode 191 connected thereto are formed on a substrate 110. A roof layer 285 is formed on the pixel electrode 191 to be spaced apart from the pixel electrode 191 with a microcavity 200 interposed therebetween. A liquid crystal injection hole 201 is formed through the roof layer 285 to expose a portion of the microcavity 200, and a liquid crystal 3 is filled in the microcavity 200. An overcoat 295 is formed on the roof layer 285 to cover the liquid crystal injection hole 201, and seals the microcavity 200 for each pixel row.

In the display device according to the present exemplary embodiment, an edge region ED surrounding a pixel region PX is formed, and the edge region ED overlaps a portion of a first valley V1.

The microcavity 200 is formed in at least a portion of the edge region ED as well as the pixel region PX. That is, the roof layer 285 is formed along the pixel row, and extends to some regions of the first valley V1. Accordingly, the microcavity 200 is formed in the edge region ED overlapping the first valley V1.

The roof layer 285 is formed to be inclined. The height of the roof layer 285 may be gradually reduced from the center of the pixel region PX to the edge region ED. Since the microcavity 200 is formed under the roof layer 285, the thickness of the microcavity 200 is changed according inclination of the roof layer 285. Accordingly, the thickness of the microcavity 200 positioned in the edge region ED is less than the thickness of the microcavity 200 positioned in the pixel region PX. In this case, the thickness of the microcavity 200 is gradually reduced from the center of the pixel region PX to the edge region ED.

The liquid crystal 3 filling the microcavity 200 is injected through the liquid crystal injection hole 201 by using a capillary phenomenon. In the present exemplary embodiment, the microcavity 200 may be formed to be small around the liquid crystal injection hole 201, thus increasing capillary force. Accordingly, it is possible to prevent a region in which the liquid crystal 3 is not injected from being formed. Further, alignment layers 11 and 21 are formed by injecting an alignment agent through the liquid crystal injection hole 201 by using the capillary phenomenon, and it is possible to prevent formation of residual materials of the alignment layer in the pixel region PX due to an improvement in capillary force.

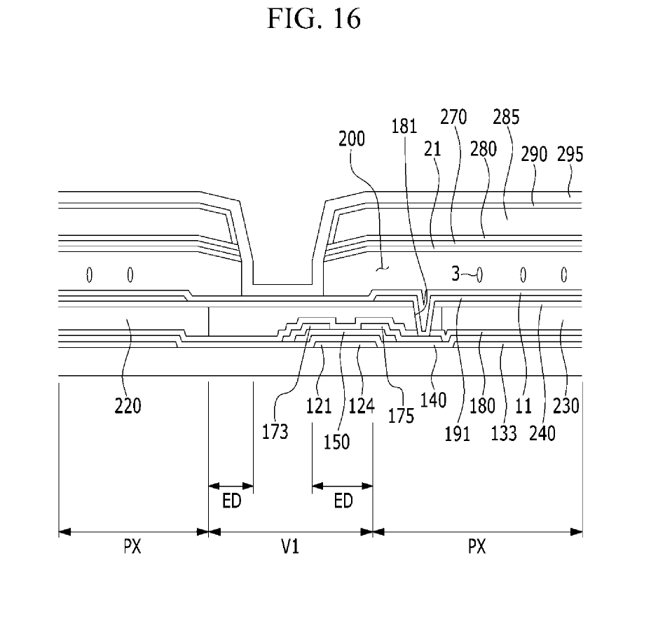

Hereinafter, the display device according to an exemplary embodiment of the present invention will be described below with reference to FIG. 16.

Since the display device according to the exemplary embodiment of the present invention illustrated in FIG. 16 has many same elements as the display device according to the exemplary embodiment of the present invention illustrated in FIG. 15, a description thereof will be omitted and only a difference will be described below. One difference with the previous exemplary embodiment is that the thickness of the microcavity is changed in the edge region, and will be described in more detail below.

FIG. 16 is a cross-sectional view illustrating a portion of the display device according to the exemplary embodiment of the present invention. FIG. 16 illustrates a portion of the two adjacent pixels belonging to the same pixel column.

In the display device according to the present exemplary embodiment, the microcavity 200 is formed in at least a portion of the pixel region PX and the edge region ED.

The roof layer 285 is formed to be inclined in the edge region ED. The roof layer 285 is formed to be flat in the pixel region PX, and a height thereof is gradually reduced away from the pixel region PX in the edge region ED. Since the microcavity 200 is formed under the roof layer 285, the thickness is changed according inclination of the roof layer 285. Accordingly, the thicknesses of the microcavities 200 are uniform in the pixel region PX, and the cell gaps are uniform in the pixel region PX. The thickness of the microcavity 200 is gradually reduced away from the pixel region PX in the edge region ED.

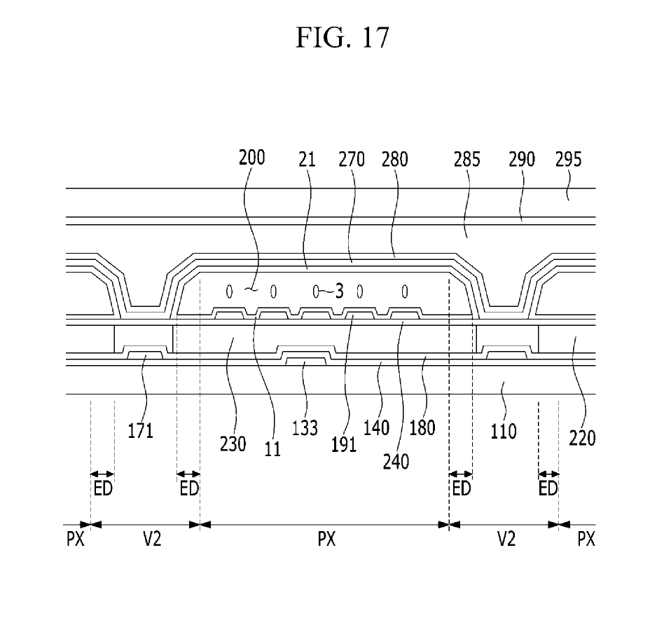

Hereinafter, the display device according to an exemplary embodiment of the present invention will be described below with reference to FIG. 17.

Since the display device according to the exemplary embodiment of the present invention illustrated in FIG. 17 has many same elements as the display device according to the exemplary embodiment illustrated in FIG. 16, a description thereof will be omitted and only a difference will be described below. One difference with the previous exemplary embodiment is that the microcavity is formed in the edge region overlapping the second valley, and will be described in more detail below.

FIG. 17 is a cross-sectional view illustrating a portion of the display device according to the exemplary embodiment of the present invention. FIG. 17 illustrates a portion of the two adjacent pixels belonging to the same pixel row.

In the display device according to the present exemplary embodiment, an edge region ED surrounding a pixel region PX is formed, and the edge region ED overlaps a portion of a second valley V2.

A microcavity 200 is formed in at least a portion of the edge region ED as well as the pixel region PX. A roof layer 285 is formed to come into contact with a first insulating layer 240 only at a portion of the center of the second valley V2, and formed to be spaced apart from the first insulating layer 240 at both edges of the second valley V2. Accordingly, the microcavity 200 is formed in the edge region ED overlapping the second valley V2.

The roof layer 285 is formed to be inclined in the edge region ED. The roof layer 285 is formed to be flat in the pixel region PX, and a height thereof is gradually reduced away from the pixel region PX in the edge region ED. Since the microcavity 200 is formed under the roof layer 285, the thickness of the microcavity 200 is changed according inclination of the roof layer 285. Accordingly, the thicknesses of the microcavities 200 are uniform in the pixel region PX, and the cell gaps are uniform in the pixel region PX. The thickness of the microcavity 200 is gradually reduced away from the pixel region PX in the edge region ED.

The case where the microcavity 200 extends to the edge region ED overlapping the first valley V1 is described in the exemplary embodiment illustrated in FIG. 16, and the case where the microcavity 200 extends to the edge region ED overlapping the second valley V2 is described in the exemplary embodiment illustrated in FIG. 17, but the present invention is not limited thereto. The microcavity 200 may be formed to extend to the entire edge region ED overlapping the first valley V1 and the second valley V2.

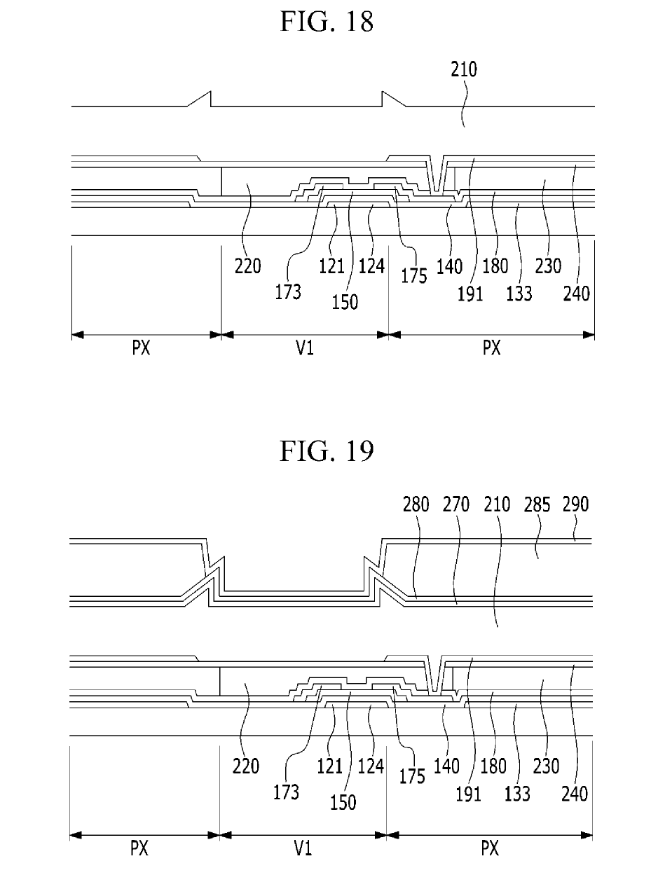

Hereinafter, a method of manufacturing the display device according to an exemplary embodiment of the present invention will be described below with reference to FIGS. 18 to 21.

FIGS. 18 to 21 are process cross-sectional views illustrating a method of manufacturing the display device according to the exemplary embodiment of the present invention.

First, as illustrated in FIG. 18, a gate line 121 extending in one direction and a gate electrode 124 protruding from the gate line 121 are formed on a substrate 110 formed of glass, plastic, or the like. Further, a storage electrode 133 is formed to be spaced apart from the gate line and the gate electrode 124. The storage electrode 133 may be formed of the same material as the gate line and the gate electrode 124.

A gate insulating layer 140 is formed on an entire surface of the substrate 110 including the gate line 121, the gate electrode 124, and the storage electrode 133 by using an inorganic insulating material such as silicon oxide or silicon nitride.

A semiconductor material such as amorphous silicon, polycrystalline silicon, or metal oxide is deposited on the gate insulating layer 140, and then patterned to form a semiconductor layer 150. The semiconductor layer 150 may be positioned on the gate electrode 124.

A data line 171 extending in another direction is formed by depositing a metal material and then patterning the metal material. Further, a source electrode 173 protruding from the data line 171 and a drain electrode 175 spaced apart from the source electrode 173 are formed together on the semiconductor layer 150.

The semiconductor material and the metal material may be continuously deposited, and then patterned simultaneously to form the semiconductor layer 150, the data line 171, the source electrode 173, and the drain electrode 175. In this case, the semiconductor layer 150 is formed to extend to a lower portion of the data line 171.

The gate electrode 124, the semiconductor layer 150, the source electrode 173, and the drain electrode 175 constitute one thin film transistor.

A passivation layer 180 is formed on the data line 171, the source electrode 173, the drain electrode 175, and the semiconductor layer 150 exposed between the source and the drain electrodes 173 and 175.

A color filter 230 is formed in each pixel region on the passivation layer 180, and a light blocking member 220 is formed on a boundary portion of each pixel region and the thin film transistor.

A first insulating layer 240 is formed of an inorganic insulating material such as silicon nitride (SiNₓ) and silicon oxide (SiOₓ) on the color filter 230 and the light blocking member 220.

A contact hole 181 is formed to expose a portion of the drain electrode 175 by etching the first insulating layer 240, the light blocking member 220, and the passivation layer 180.

A transparent metal material such as indium-tin oxide (ITO) and indium-zinc oxide (IZO) is deposited on the first insulating layer 240, and then patterned to form a pixel electrode 191 in the pixel region. The pixel electrode 191 is formed to be connected through the contact hole 181 to the drain electrode 175.

A sacrificial layer 210 is formed of an organic insulating material on the pixel electrode 191 and the first insulating layer 240. The sacrificial layers 210 are patterned to be separated between the pixel regions adjacent in one direction and to be connected along the pixel regions adjacent in another direction. For example, the sacrificial layers 210 formed in the pixel regions belonging to the same pixel row may be formed to be separated from each other, and the sacrificial layers 210 formed in the pixel regions belonging to the same pixel column may be formed to be connected to each other. That is, the sacrificial layer 210 is formed along the pixel column.

The sacrificial layer 210 may be formed of a photosensitive polymer material, and a photo-process may be performed to pattern the sacrificial layer 210.

When the sacrificial layer 210 is patterned, the sacrificial layers 210 may be formed to have different thicknesses by using a slit mask or a halftone mask. The thickness of the sacrificial layer 210 positioned at some edges of the pixel region PX may be larger than that of a residual portion. Particularly, the thickness of the sacrificial layer 210 may be large at the edge of the pixel region PX positioned at a portion adjacent to the first valley V1 positioned between a plurality of pixel rows. The liquid crystal injection hole is formed in the first valley V1 afterward, and the thickness of the sacrificial layer 210 positioned at a portion that is in contact with the liquid crystal injection hole may be greater than the thickness of a residual portion.

As illustrated in FIG. 19, a common electrode 270 is formed by depositing a metal material on the sacrificial layer 210.

A second insulating layer 280 may be formed of an inorganic insulating material such as silicon oxide or silicon nitride on the common electrode 270.

A roof layer 285 is formed of an organic material on the second insulating layer 280, and patterned to remove the roof layer 285 positioned in the first valley V1.

After the roof layer 285 is patterned and then cured at low temperatures (ex. 120 degrees, 60 minutes), a third insulating layer 290 may be formed of an inorganic insulating material such as silicon nitride (SiNₓ) and silicon oxide (SiOₓ) on the roof layer 285. The third insulating layer 290 may be formed on the patterned roof layer 285 to protect a lateral surface of the roof layer 285 by covering the lateral surface.

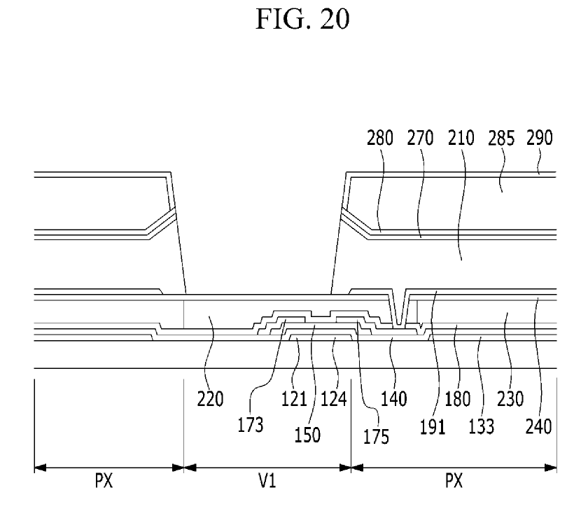

As illustrated in FIG. 20, the third insulating layer 290, the second insulating layer 280, and the common electrode 270 are patterned to remove the third insulating layer 290, the second insulating layer 280, and the common electrode 270 positioned in the first valley V1. Accordingly, the sacrificial layer 210 positioned under a portion from which the common electrode 270 is removed is exposed.

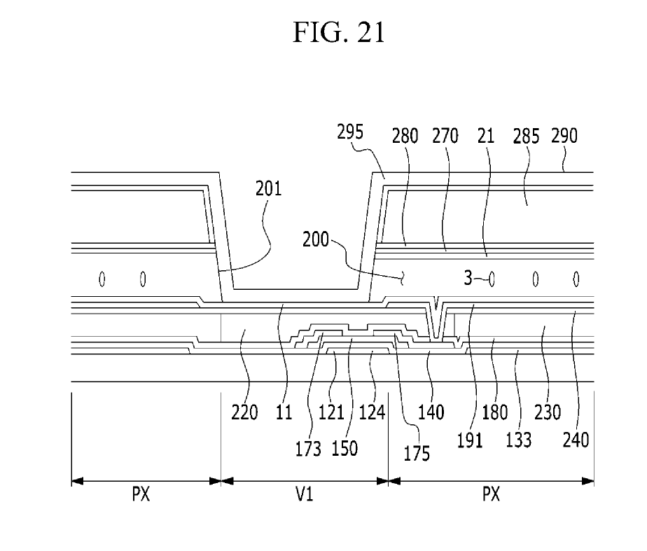

As illustrated in FIG. 21, an oxygen plasma is provided on the substrate 110 in which the sacrificial layer 210 is exposed to perform ashing, or a developing solution is provided to remove an entire surface of the sacrificial layer 210. When the sacrificial layer 210 is removed, a microcavity 200 is formed in a portion in which the sacrificial layer 210 was positioned. That is, the pixel electrode 191 and the roof layer 285 are spaced apart from each other with the microcavity 200 interposed therebetween.

Further, the microcavity 200 is exposed to the outside through a portion in which the roof layer 285 is not formed, which is called a liquid crystal injection hole 201.

After the microcavity 200 is formed, the roof layer 285 is cured at high temperature (ex. 220 degrees, 60 minutes). By the curing process at high temperature a shape of the roof layer 285 is deformed. An edge portion of the roof layer 285 goes down. Thus, a thickness of an edge portion of the microcavity 200 becomes similar to a thickness of the remainder portion of the microcavity 200.

An alignment agent including an alignment material is dropped around the liquid crystal injection hole 201 by a spin coating manner or an inkjet manner to form a first alignment layer 11 and a second alignment layer 21 in the microcavity 200. The first alignment layer 11 is formed on the pixel electrode 191, and the second alignment layer 21 is formed under the common electrode 270.

When the liquid crystal 3 formed of liquid crystal molecules is dropped around the liquid crystal injection hole 201 by an inkjet manner or a dispensing manner, the liquid crystal 3 is injected through the liquid crystal injection hole 201 into the microcavity 200.

An overcoat 295 is formed by depositing a material that does not react with the liquid crystal 3 on the third insulating layer 290. The overcoat 295 is formed to cover the liquid crystal injection hole 201 through which the microcavity 200 is exposed to the outside, thus sealing the microcavity 200.

According to the exemplary embodiments of the present invention, the display device and the method of manufacturing the same can alleviate stress applied to a roof layer of a display device, to suppress deformation of the roof layer. Further, an injection ability of an alignment agent can be improved by expanding a microcavity to an edge region surrounding a pixel region and reducing a thickness of the microcavity in the edge region. Further, a cell gap of the microcavity positioned under the roof layer can be set to be uniform by forming a sacrificial layer in a direction that is opposite to a deformation direction of the roof layer.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display device comprising:
a substrate comprising a plurality of pixel regions;
a thin film transistor disposed on the substrate;
a pixel electrode connected to the thin film transistor and disposed in a first pixel region; and
a roof layer disposed on the pixel electrode and spaced apart from the pixel electrode with a microcavity interposed therebetween,
wherein the plurality of pixel regions is disposed in a matrix form comprising a plurality of pixel rows and a plurality of pixel columns,
the roof layer is disposed along the plurality of pixel rows, and
the roof layer comprises a bridge portion connecting the roof layers disposed in different pixel rows.

2. The display device of claim 1, further comprising:
a first valley disposed between the plurality of pixel rows; and
a second valley disposed between the plurality of pixel columns,
wherein the bridge portion is disposed in the first valley.

3. The display device of claim 2, wherein:
the bridge portion is disposed at an intermediate position between two adjacent second valleys.

4. The display device of claim 2, wherein:
the bridge portion is disposed at a position at which the first valley and the second valley cross each other.

5. The display device of claim 2, wherein:
a height of the bridge portion is lower than a height of the roof layer disposed in the first pixel region.

6. A display device, comprising:
a substrate comprising a plurality of pixel regions;
a thin film transistor disposed on the substrate;
a pixel electrode connected to the thin film transistor and disposed in a first pixel region; and
a roof layer disposed on the pixel electrode and spaced apart from the pixel electrode with a microcavity interposed therebetween,
wherein microcavities are disposed in the pixel regions and are connected to each other.

7. The display device of claim 6, wherein:
the plurality of pixel regions is disposed in a matrix form comprising a plurality of pixel rows and a plurality of pixel columns,
the roof layer is disposed along the plurality of pixel rows, and
the microcavities disposed in the same pixel row are connected to each other.

8. The display device of claim 7, wherein:
a height of the roof layer disposed at a boundary of the plurality of pixel regions is lower than a height of the roof layer disposed in the first pixel region.

9. The display device of claim 7, further comprising:
a first valley disposed between the plurality of pixel rows; and
a second valley disposed between the plurality of pixel columns,
wherein the microcavities are connected to each other in the second valley.

10. The display device of claim 9, wherein:
the roof layer comprises a bridge portion connecting the roof layers disposed in different pixel rows.

11. The display device of claim 10, wherein:
the bridge portion is disposed at a position at which the first valley and the second valley cross each other.

12. The display device of claim 11, further comprising:
a liquid crystal injection hole disposed in the roof layer to expose a portion of the microcavity,
wherein the liquid crystal injection hole is disposed in the first valley.

13. The display device of claim 12, wherein:
a shape of the liquid crystal injection hole in a top plan view is any one of a circle, an oval, a quadrangle, and a rhombus.

14. A display device, comprising:
a substrate comprising a plurality of pixel regions;
a thin film transistor disposed on the substrate;
a pixel electrode connected to the thin film transistor and disposed in a first pixel region; and
a roof layer disposed on the pixel electrode and spaced apart from the pixel electrode with a microcavity interposed therebetween,
wherein the roof layer comprises a protruding portion protruding from an first side and a second side of the first pixel region.

15. The display device of claim 14, wherein:
a shape of the protruding portion is any one of a triangle, a quadrangle, and a round shape.

16. A display device, comprising:
a substrate comprising a plurality of pixel regions;
a thin film transistor disposed on the substrate;
a pixel electrode connected to the thin film transistor and disposed in a first pixel region; and
a roof layer disposed on the pixel electrode and spaced apart from the pixel electrode with a microcavity interposed therebetween,
wherein the microcavity is disposed in at least a portion of the first pixel region and an edge region surrounding the first pixel region.

17. The display device of claim 16, wherein:
a thickness of the microcavity disposed in the edge region is less than a thickness of the microcavity disposed in the first pixel region.

18. The display device of claim 17, wherein:
the thickness of the microcavity gradually decreases from a central portion of the first pixel region to the edge region.

19. The display device of claim 17, wherein:
the thicknesses of the microcavities disposed in the first pixel region are uniform, and
the thickness of the microcavity disposed in the edge region gradually decreases away from the first pixel region.

20. A method of manufacturing a display device, the method comprising:
forming a thin film transistor on a substrate;
forming a pixel electrode connected to the thin film transistor, the pixel electrode being disposed in a pixel region;
forming a sacrificial layer on the pixel electrode;
forming a roof layer on the sacrificial layer;
forming a liquid crystal injection hole in the roof layer to expose a portion of the sacrificial layer;
removing the sacrificial layer to form a microcavity between the pixel electrode and the roof layer;
curing the roof layer;
injecting liquid crystal through the liquid crystal injection hole; and
forming an overcoat layer on the roof layer to seal the microcavity for each pixel region,
wherein a thickness of the sacrificial layer formed at a portion that is in contact with the liquid crystal injection hole is greater than a thickness of a residual portion.
